(19) United States
(12) Patent Application Publication
(10) Pub. No.: US 2025/0355084 A1
(43) Pub. Date: Nov. 20, 2025

(54) ARRIVAL DIRECTION ESTIMATION DEVICE AND ARRIVAL DIRECTION ESTIMATION METHOD

(71) Applicant: Murata Manufacturing Co., Ltd., Nagaokakyo-shi (JP)

(72) Inventor: Katsuhisa KASHIWAGI, Nagaokakyo-shi (JP)

(73) Assignee: Murata Manufacturing Co., Ltd., Nagaokakyo-shi (JP)

(21) Appl. No.: 19/291,692

(22) Filed: Aug. 6, 2025

Related U.S. Application Data
(63) Continuation of application No. PCT/JP2024/000802, filed on Jan. 15, 2024.

(30) Foreign Application Priority Data
Apr. 6, 2023 (JP) 2023-062121

(51) Int. Cl. G01S 7/40; G01S 3/48; H01Q 21/06

(52) U.S. Cl. CPC G01S 7/4013; G01S 3/48; H01Q 21/061

(57) ABSTRACT

An arrival direction estimation device and method are provided to accurately estimating the arrival direction of a radio wave by discriminating true signals from false images caused by antenna imperfections. The device includes an array antenna having a plurality of antenna elements arranged in one direction; a target estimation circuit that estimates an arrival direction of a radio wave based on reception signals from the antenna elements. To validate these arrival directions, an electric power estimation circuit estimates the received electric power for each arrival direction for across a plurality of sub-array antennas having a same number of the antenna elements. A target discrimination circuit determines if a variation amount of the electric power in the arrival direction estimated for each of the sub-array antennas is equal to or less than a predetermined value. An arrival direction with a low power variation is designated as the arrival direction estimation target.

### CROSS-REFERENCE TO RELATED APPLICATIONS

The present application is a continuation of International Application No. PCT/JP2024/000802, filed Jan. 15, 2024, which claims priority to Japanese patent application JP 2023-062121, filed Apr. 6, 2023, the entire contents of each of which being incorporated herein by reference.

### TECHNICAL FIELD

The present disclosure relates to an arrival direction estimation device and an arrival direction estimation method.

### BACKGROUND ART

In a communication device or a radar (radio detection and ranging), it is a common technique to estimate the arrival direction of a radio wave using an array antenna obtained by arraying a plurality of antennas. In the arrival direction estimation technique in which such an array antenna is used, sometimes a direction different from the actual arrival direction of the radio wave is estimated as the arrival direction of the radio wave. Patent Document 1 discloses a technique in which the arrival direction of a radio wave is estimated based on a signal obtained by subarraying a plurality of antennas capable of receiving two orthogonal polarized waves, weighting the reception signal of each antenna belonging to each sub-array antenna using at least one of phase shift and amplitude adjustment, and combining the weighted results; at the same time, the arrival direction of the radio wave is also estimated based on the respective reception signals of the plurality of antennas. Directions different from the actual arrival direction of the radio wave are removed based on the difference of the two estimation results.

### CITATION LIST

### Patent Document

Patent Document 1: Japanese Unexamined Patent Application Publication No. 2019-57791

### SUMMARY

### Technical Problems

In the conventional technique described above, when the arrival direction estimation using the reception signal of each sub-array antenna and the arrival direction estimation using the reception signal outputted from each antenna are performed in parallel, two arrival direction estimation means are required, so that the mounting cost may become high. Alternatively, when different arrival direction estimation processes are performed in time division manner, the processing speed may be lowered.

The present disclosure has been made in view of the above problems, and it is an object of the present disclosure to realize an arrival direction estimation device and an arrival direction estimation method capable of appropriately estimating the arrival direction of a radio wave by a simple configuration or processing.

### Solutions to Problems

An arrival direction estimation device according to an aspect of the present disclosure includes: an array antenna having a plurality of antenna elements, respective phase centers of the plurality of antenna elements being arranged in one direction; a target estimation unit that estimates an arrival direction of a radio wave based on a reception signal for each of the antenna elements; an electric power estimation unit that estimates an electric power in the arrival direction for each of a plurality of sub-array antennas each including the same number of the antenna elements; and a target discrimination unit that determines, when a variation amount of the electric power in the arrival direction estimated for each of the sub-array antennas is equal to or less than a predetermined value, the arrival direction as an arrival direction estimation target.

With such a configuration, the arrival direction estimation target and false images caused by side lobes can be discriminated, and the influence of the side lobes, which increase due to the phase shift between the antenna elements, can be suppressed. In addition, the arrival direction of the radio wave can be appropriately estimated by a simple configuration.

An arrival direction estimation method according to an aspect of the present disclosure includes: a target estimation step that estimates an arrival direction of a radio wave based on a reception signal for each of antenna elements whose respective phase centers are arranged in one direction; an electric power estimation step that estimates an electric power in the arrival direction for each of a plurality of sub-array antennas each including the same number of the antenna elements; and a target determination step that determines, if a variation amount of the electric power in an arrival direction estimated for each of the sub-array antennas is equal to or less than a predetermined value, the arrival direction as an arrival direction estimation target.

With such a configuration, the arrival direction estimation target and false images caused by side lobes can be discriminated, and the influence of the side lobes, which increase due to the phase shift between the antenna elements, can be suppressed. In addition, the arrival direction of the radio wave can be appropriately estimated by simple processing.

### Advantageous Effects

According to the present disclosure, it is possible to realize an arrival direction estimation device and an arrival direction estimation method capable of appropriately estimating the arrival direction of a radio wave by a simple configuration or processing.

### BRIEF DESCRIPTION OF DRAWINGS

FIG. 1 is a block diagram showing a schematic configuration of an arrival direction estimation device according to an embodiment.

FIG. 2 is a schematic diagram showing an example of an antenna mounting surface of a dielectric substrate constituting an array antenna.

FIG. 3A is a conceptual diagram showing the positional relationship between the arrival direction estimation device according to the embodiment and an arrival direction estimation target.

FIG. 3B is a conceptual diagram showing positions of the arrival directions estimated from the reception signal of each of antenna elements.

FIG. 4 is a conceptual diagram showing the arrival direction of a radio wave from the arrival direction estimation target.

FIG. 5 is a conceptual diagram showing the relationship between phase centers and phase differences of the antenna elements.

FIG. 6 is a conceptual diagram showing variations in the phase centers of the antenna elements.

FIG. 7 is a flowchart showing an example of an arrival direction estimation process performed by the arrival direction estimation device according to the embodiment.

FIG. 8 is a conceptual diagram showing an example of a sub-array configuration according to the embodiment.

FIG. 9 is a conceptual diagram showing an example of the definition of the phase center position of each of the antenna elements in the sub-array configuration according to the embodiment.

FIG. 10 is a flowchart showing an example of an electric power estimation process.

FIG. 11 is a graph obtained by plotting the electric power in the arrival direction in the arrangement direction of sub-arrays.

FIG. 12 is a flowchart showing an example of a target discrimination process.

FIG. 13 is a conceptual diagram showing a first example of an antenna configuration according to a first modification of the embodiment.

FIG. 14 is a conceptual diagram showing a second example of the antenna configuration according to the first modification of the embodiment.

FIG. 15 is a conceptual diagram showing a first example of a sub-array configuration according to a second modification of the embodiment.

FIG. 16 is a conceptual diagram showing a second example of the sub-array configuration according to the second modification of the embodiment.

### DESCRIPTION OF EMBODIMENTS

An arrival direction estimation device and an arrival direction estimation method according to an embodiment will be described below in detail based on the drawings. Note that the present disclosure is not limited to such an embodiment.

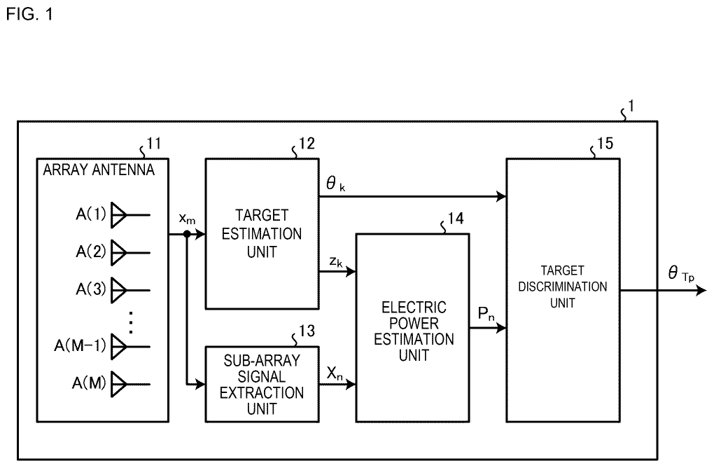

FIG. 1 is a block diagram showing a schematic configuration of the arrival direction estimation device according to the embodiment. An arrival direction estimation device 1 according to the embodiment includes an array antenna 11, a target estimation unit 12, a sub-array signal extraction unit 13, an electric power estimation unit 14, and a target discrimination unit 15. As used herein, “unit” refers to circuitry that may be configured via the execution of computer readable instructions, and the circuitry may include one or more local processors (e.g., CPU's), and/or one or more remote processors, such as a cloud computing resource, or any combination thereof.

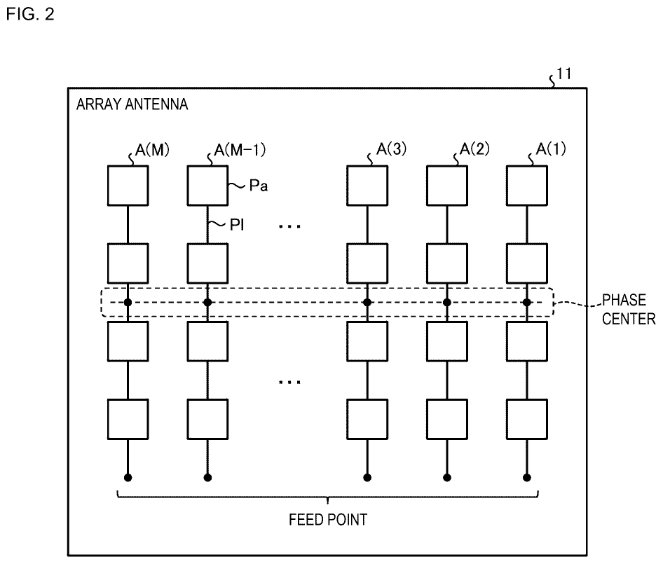

FIG. 2 is a schematic diagram showing an example of an antenna mounting surface of a dielectric substrate constituting the array antenna. In the present embodiment, the array antenna 11 is an equal-interval linear array antenna in which the phase centers of a plurality of antenna elements A(m) (m is an integer from 1 to M) are arranged at equal intervals in one direction, as shown in FIG. 2. Each of the antenna elements A(m) has a plurality of patch antennas Pa provided on the dielectric substrate and connected by a feed line P1, and a feed point is provided at one end of the feed line P1. In the present disclosure, the array antenna 11 is not limited to the aspect shown in FIG. 2 as long as it is at least an aspect in which the phase centers are arranged in one direction.

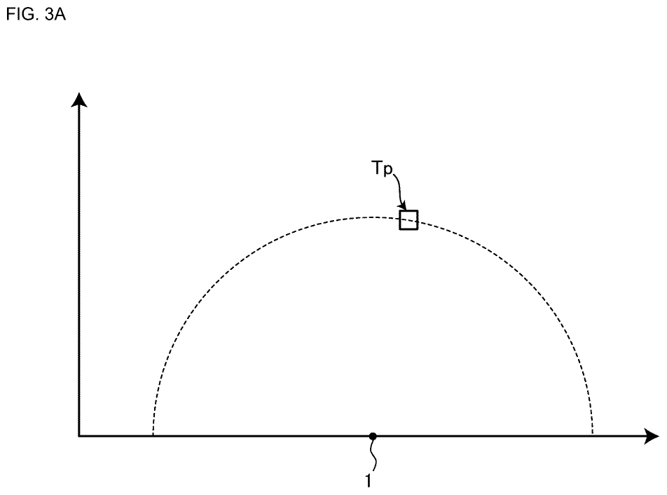

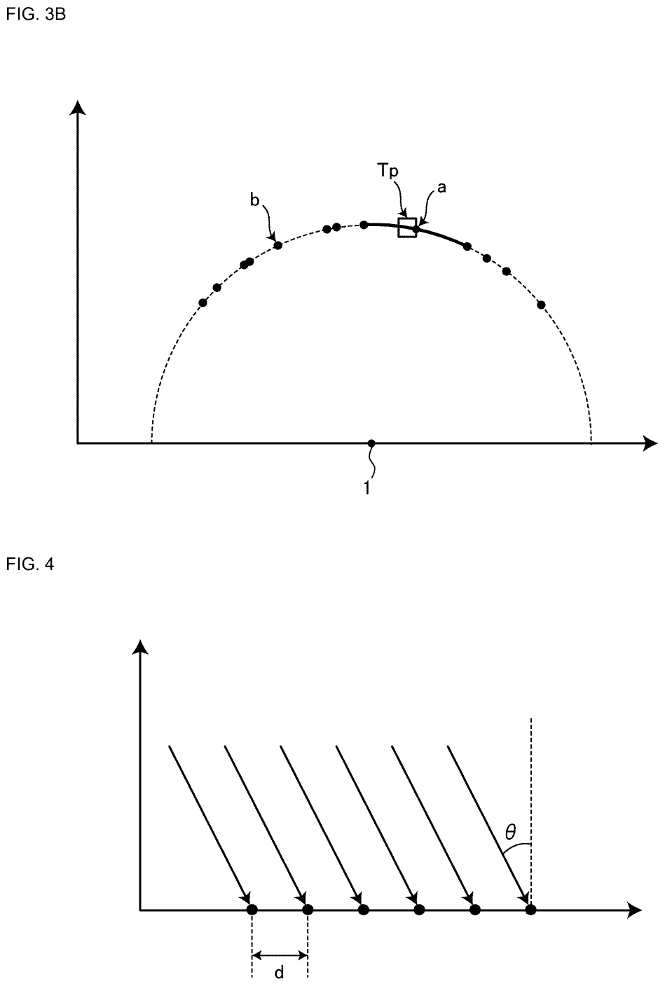

FIG. 3A is a conceptual diagram showing a positional relationship between the arrival direction estimation device according to the embodiment and an arrival direction estimation target. FIG. 3B is a conceptual diagram showing positions of the arrival directions estimated from the reception signals of the respective antenna elements. In FIGS. 3A and 3B, the horizontal axis indicates the arrangement direction of the antenna elements A(m), and the vertical axis indicates the direction orthogonal to the arrangement direction of the antenna elements A(m). A point a shown in FIG. 3B indicates a position corresponding to an arrival direction estimation target Tp of the arrival direction estimation device 1 according to the embodiment, and a plurality of points b indicate false images appearing in directions different from the arrival direction estimation target Tp.

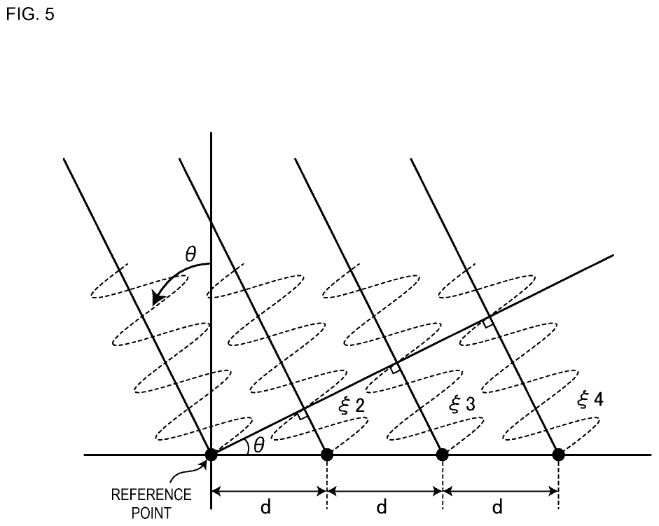

FIG. 4 is a conceptual diagram showing the arrival direction of a radio wave from the arrival direction estimation target. FIG. 5 is a conceptual diagram showing the relationship between phase centers and phase differences of the antenna elements. In FIGS. 4 and 5, the horizontal axis indicates the arrangement direction of the antenna elements, and the vertical axis indicates the direction orthogonal to the arrangement direction of the antenna elements. Black dots in FIGS. 4 and 5 indicates the phase centers of the antenna elements. In FIGS. 4 and 5, the phase centers of the antenna elements are arranged side by side on the horizontal axis. In FIG. 4, the phase centers of six antenna elements are exemplified.

In an ideal array antenna, the interval d between the phase centers of the respective antenna elements is a constant. In an ideal array antenna, the interval d between the phase centers of the respective antenna elements is, for example, λ/2(λ represents the wavelength of the radio wave received by the respective antenna elements). The arrival direction of the radio wave from the arrival direction estimation target Tp is defined by an arrival angle θ with the direction orthogonal to the arrangement direction of the antenna elements set to 0 degrees. The phase φ(d, θ) between the respective antenna elements in the arrival direction estimation target Tp at this time is expressed by the following Equation (1).

$$\begin{matrix}[ Equation 1 ] & \\ ϕ ( d , θ ) = \frac{2 π d}{λ} sin θ & ( 1 )\end{matrix}$$

As shown in FIG. 5, when the phase center of a certain antenna element is regarded as a reference point, the radio wave from the arrival direction estimation target Tp is incident on the respective antenna elements with phase differences of ξ2, ξ3, ξ4, . . . , respectively, for example. The arrival direction of the radio wave can be estimated from the phase differences.

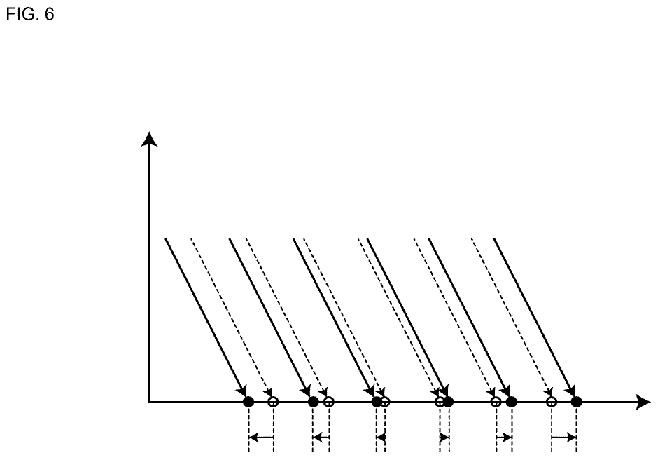

On the other hand, as shown in FIG. 6, variations in the phase centers of the respective antenna elements A(m) in an actual array antenna occur due to manufacturing variations, aging of the array antenna, or electromagnetic interaction between the antenna elements (i.e., inter-antenna electromagnetic coupling). FIG. 6 is a conceptual diagram showing the variations in the phase centers of the antenna elements. When the interval between the phase centers of the respective antenna elements is d′, the phase φ(d′, θ) is expressed by the following Equation (2).

$$\begin{matrix}[ Equation 2 ] & \\ ϕ ( {d}^{′} , θ ) = \frac{2 π {d}^{′}}{λ} sin θ & ( 2 )\end{matrix}$$

The phase φ(d′, θ) shown in the above Equation (2) includes the variations in the phase centers of the respective antenna elements in an actual array antenna. Due to the variations in the phase centers of the respective antenna elements, the power of side lobes increase, which results in a plurality of false images b as shown in FIG. 3B, that appear in directions different from a position a corresponding to the arrival direction estimation target Tp, in addition to the position a corresponding to the arrival direction estimation target Tp.

Therefore, in the present disclosure, the array antenna 11 is subarrayed, and the electric power in the arrival direction is estimated for each sub-array; when the variation amount in the electric power in an arrival direction estimated for each sub-array is equal to or less than a predetermined value, such an arrival direction is determined to be the arrival direction estimation target Tp. Thus, the false images b appearing in the directions different from the position a corresponding to the arrival direction estimation target Tp can be excluded.

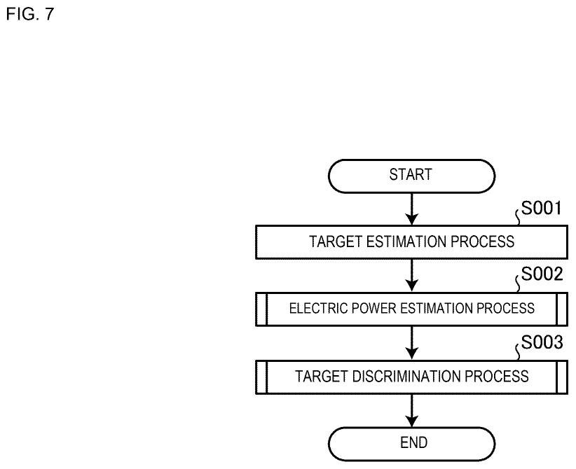

Specific examples of the processing in each of the target estimation unit 12, the sub-array signal extraction unit 13, the electric power estimation unit 14, and the target discrimination unit 15 of the arrival direction estimation device 1 according to the embodiment will be described below. FIG. 7 is a flowchart showing an example of an arrival direction estimation process performed by the arrival direction estimation device according to the embodiment.

In the arrival direction estimation process shown in FIG. 7, the arrival direction estimation device 1 estimates an arrival angle θk of the radio wave (hereinafter also referred to as “target angle θk”) based on a reception signal Xₘ Of each antenna element A(m) (a target estimation process, step S001). The target estimation process (the arrival direction estimation process) is executed by the target estimation unit 12. Examples of the arrival direction estimation technique in the target estimation unit 12 include an annihilating filter method (hereinafter also referred to as “AF method”) using an annihilating filter, a FFT, a Prony method, a beamformer method (hereinafter also referred to as “BF method”), a MUSIC (multiple signal classification) method, and the like. Note that high angular resolution can be obtained when the AF method, for example, is used as the arrival direction estimation technique in the target estimation unit 12. Thus, a plurality of targets whose angles are close to each other can be isolated.

The target angle θk can be expressed by the following Equation (3). The target estimation unit 12 generates a phase difference zₖ between antenna elements corresponding to the target angle θk expressed by the following Equation (3). The phase difference Zₖ between antenna elements can be expressed by the following Equation (4).

$$\begin{matrix}[ Equation 3 ] & \\ {ϕ}_{k} ( d , {θ}_{k} ) = \frac{2 π d}{λ} sin {θ}_{k} & ( 3 )\end{matrix}$$

$$\begin{matrix}[ Equation 4 ] & \\ {z}_{k} = exp ( j {ϕ}_{k} ) & ( 4 )\end{matrix}$$

The number of arrival directions estimated in the observation range of the arrival direction estimation device 1 is an unknown number. The target angle θk (k is an integer from 1 to K, where K is an unknown number) estimated by the target estimation unit 12 may include a plurality of target angles θk that correspond to, respectively, a position corresponding to the arrival direction estimation target Tp, and positions different from the arrival direction estimation target Tp. Hereinafter, the arrival direction estimated by the target estimation unit 12 is also referred to as “arrival direction k” or a “candidate arrival direction”.

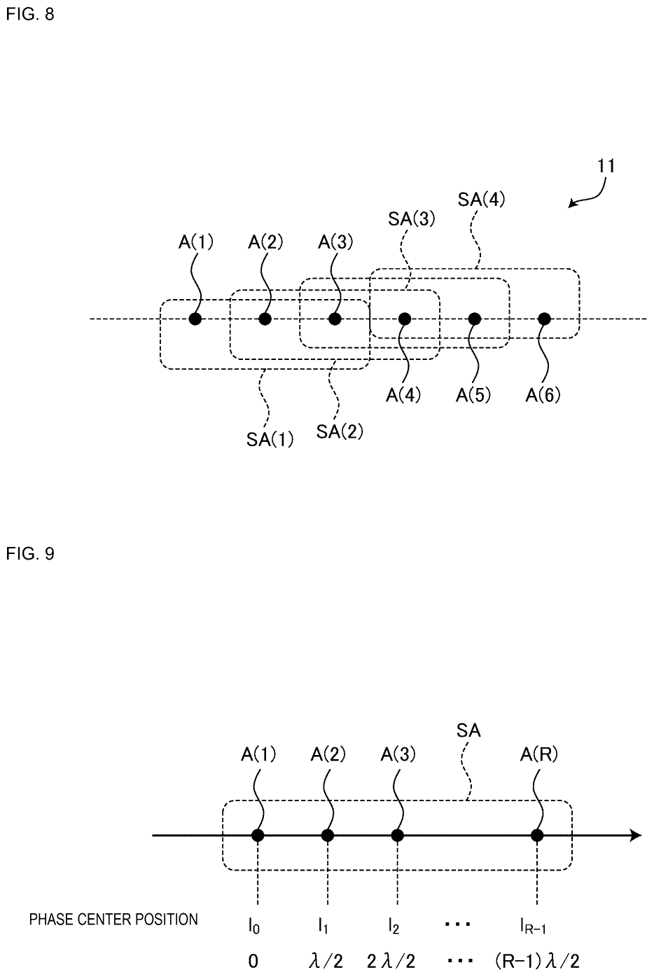

FIG. 8 is a conceptual diagram showing an example of a sub-array configuration according to the embodiment. FIG. 8 shows an example of an equal-interval linear array antenna in which the respective phase centers of the antenna elements A(m) are arranged at substantially equal intervals, wherein the phase centers of the antenna elements A(m) are arranged in order from one end of the array antenna 11 (the left end in FIG. 8), and sub-array antennas SA(n) with element number R (n is an integer from 1 to N, where N<M) are arranged while shifting by one element. In FIG. 8, the element number M of the array antenna 11 is 6, the total number N of the sub-array antennas SA(n) is 4, and the element number R of each of the sub-array antennas SA(n) is 3.

The element number M of the array antenna 11, the total number N of the sub-array antennas SA(n), and the element number R of each of the sub-array antennas SA(n) shown in FIG. 8 are an example, and are not limited to such an example. In the present disclosure, each of the sub-array antennas SA(n) has the same number of antenna elements R and substantially the same interval between the respective phase centers of the antenna elements adjacent in the arrangement direction of antenna elements A(r) (r is an integer from 1 to R). Thus, the sub-arrays are structurally uniform.

Specifically, in the example shown in FIG. 8, the interval between the phase center of the antenna element A(1) and the phase center of the antenna element A(2) included in the sub-array antenna SA(1), the interval between the phase center of the antenna element A(2) and the phase center of the antenna element A(3) included in the sub-array antenna SA(2), the interval between the phase center of the antenna element A(3) and the phase center of the antenna element A(4) included in the sub-array antenna SA(3), and the interval between the phase center of the antenna element A(4) and the phase center of the antenna element A(5) included in the sub-array antenna SA(4) are substantially the same.

Further, in the example shown in FIG. 8, the interval between the phase center of the antenna element A(2) and the phase center of the antenna element A(3) included in the sub-array antenna SA(1), the interval between the phase center of the antenna element A(3) and the phase center of the antenna element A(4) included in the sub-array antenna SA(2), the interval between the phase center of the antenna element A(4) and the phase center of the antenna element A(5) included in the sub-array antenna SA(3), and the interval between the phase center of the antenna element A(5) and the phase center of the antenna element A(6) included in the sub-array antenna SA(4) are substantially the same.

Note that, when the array antenna 11 is an equal-interval linear array antenna, the intervals between the phase centers of all adjacent antenna elements A(r) in each of the sub-array antennas SA(n) are substantially the same.

FIG. 9 is a conceptual diagram showing an example of the definition of the phase center position of each of the antenna elements in the sub-array configuration according to the embodiment. In FIG. 9, in a sub-array antenna SA with element number R, the phase center position of each of the antenna elements A(r) is lᵣ₋₁.

Specifically, in the example shown in FIG. 9, the phase center position of the antenna element A(1) is lₒ, the phase center position of the antenna element A(2) is l₁, the phase center position of the antenna element A(3) is l₂, and the phase center position of the antenna element A(R) is l_{R-1}.

When the interval between the respective antenna elements A(r) is λ/2 with the phase center position lₒ of the antenna element A(1) at one end (left end in FIG. 9) of the sub-array antenna SA defined as a reference position (lₒ=0), the phase center position lᵣ₋₁ of the respective antenna elements A(r) of the sub-array antenna SA is the following: the phase center position 11 of the antenna element A(2)=λ/2, the phase center position 12 of the antenna element A(3)=2λ/2(=A), and the phase center position l_{R-1} of the antenna element A(R)=(R-1)λ/2.

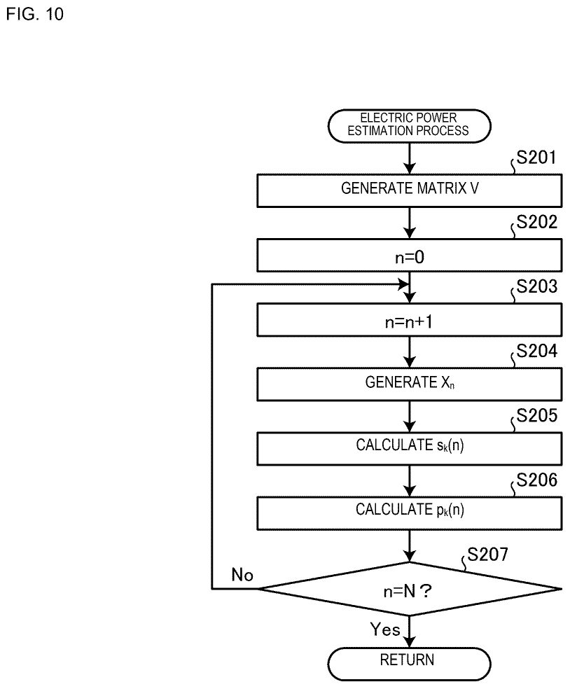

In the arrival direction estimation process shown in FIG. 7, the arrival direction estimation device 1 estimates the electric power in the arrival direction k for each sub-array antenna SA(n) (electric power estimation process, step S002). The electric power estimation process is executed by the sub-array signal extraction unit 13 and the electric power estimation unit 14. FIG. 10 is a flowchart showing an example of the electric power estimation process. Here, the concept of the processes in the sub-array signal extraction unit 13 and the electric power estimation unit 14 will be described first.

The sub-array signal extraction unit 13 generates a column vector Xₙ shown in the following Equation (5). The reception signal of each of the antenna elements A(r) in the sub-array antenna SA(n) with element number R can be generalized as Xₙ₊ᵣ₋₁.

$$\begin{matrix}[ Equation 5 ] & \\ {X}_{n} = [ \begin{matrix}{x}_{n} \\ {x}_{n + 1} \\ ⋮ \\ {x}_{n + ( R - 1 ) - 1} \\ {x}_{n + ( R - 1 )}\end{matrix} ] & ( 5 )\end{matrix}$$

When a complex amplitude Sₖ(n) of each arrival direction k in the sub-array antenna SA(n) is expressed as a column vector Sn shown in the following Equation (6) where the total number of arrival directions k is K, the column vector Xₙ shown in the above Equation (5) and a column vector Sn shown in the following Equation (6) can be expressed by a relational expression shown in the following Equation (7). V⁺ shown in the following Equation (7) is a generalized inverse matrix of a matrix V shown in the following Equation (8).

$$\begin{matrix}[ Equation 6 ] & \\ {S}_{n} = [ \begin{matrix}{s}_{1} ( n ) \\ {s}_{2} ( n ) \\ ⋮ \\ {s}_{K - 1} ( n ) \\ {s}_{K} ( n )\end{matrix} ] & ( 6 )\end{matrix}$$

$$\begin{matrix}[ Equation 7 ] & \\ {S}_{n} = {V}^{+} {X}_{n} & ( 7 )\end{matrix}$$

$$\begin{matrix}[ Equation 8 ] & \\ V = [ \begin{matrix}{z}_{1}^{{w}_{0}} & {z}_{2}^{{w}_{0}} & … & {z}_{K}^{{w}_{0}} \\ {z}_{1}^{{w}_{1}} & {z}_{2}^{{w}_{1}} & … & {z}_{K}^{{w}_{1}} \\ {z}_{1}^{{w}_{2}} & {z}_{2}^{{w}_{2}} & ⋱ & {z}_{K}^{{w}_{2}} \\ ⋮ & ⋮ & … & ⋮ \\ {z}_{1}^{{w}_{R - 1}} & {z}_{2}^{{w}_{R - 1}} & … & {z}_{K}^{{w}_{R - 1}}\end{matrix} ] & ( 8 )\end{matrix}$$

In the above Equation (8), w can be expressed by the following Equation (9).

$$\begin{matrix}[ Equation 9 ] & \\ {w}_{r} = \frac{2 {I}_{r}}{λ} & ( 9 )\end{matrix}$$

The electric power estimation unit 14 uses the complex amplitude s (n) in each arrival direction k obtained by the above Equations (5) to (9) to calculate an electric power pₖ(n) for each sub-array antenna SA(n) in each arrival direction k. The electric power pₖ(n) for each sub-array antenna SA(n) in each arrival direction k can be calculated by the following Equation (10).

$$\begin{matrix}[ Equation 10 ] & \\ {p}_{k} ( n ) = {\vert {s}_{k} ( n ) \vert}^{2} & ( 10 )\end{matrix}$$

In the electric power estimation process shown in FIG. 10, the electric power estimation unit 14 uses the phase difference zₖ between antenna elements in each arrival direction k calculated by the target estimation unit 12 to generate the matrix V shown in the above Equation (8) (step S201).

When the interval between the respective antenna elements A(r) of the sub-array antenna SA(n) is λ/2, the matrix V shown in the above Equation (8) can be transformed into the following Equation (11).

$$\begin{matrix}[ Equation 11 ] & \\ V = [ \begin{matrix}1 & 1 & … & 1 \\ {z}_{1} & {z}_{2} & … & {z}_{K} \\ {z}_{1}^{2} & {z}_{2}^{2} & ⋱ & {z}_{K}^{2} \\ ⋮ & ⋮ & … & ⋮ \\ {z}_{1}^{R - 1} & {z}_{2}^{R - 1} & … & {z}_{K}^{R - 1}\end{matrix} ] & ( 11 )\end{matrix}$$

The arrival direction estimation device 1 initializes the number n of the sub-array antenna SA(n) (“n=0” in step S202), increments the number n (“n=n+1” in step S203), and executes the subsequent processing.

The sub-array signal extraction unit 13 extracts the reception signal Xₙ₊ᵣ₋₁ of the antenna element A(r) included in each sub-array antenna SA(n), and generates the column vector Xₙ represented by the above Equation (5) (step S204).

The electric power estimation unit 14 uses the above Equations (5) to (9) to calculate the complex amplitude Sₖ(n) of each arrival direction k (step S205), and uses the above Equation (10) to calculate the electric power pₖ(n) for each sub-array antenna SA(n) in each arrival direction k (step S206).

The arrival direction estimation device 1 determines whether or not the number n of the sub-array antenna SA(n) is N (step S207), and if the number n of the sub-array antenna SA(n) is not N (“No” in step S207), in other words, if the calculation of the electric power pₖ(n) in each arrival direction k has not been completed, returns the process to step S203, increments the number n of the sub-array antenna SA(n) (“n=n+1” in step S203), and repeats the processes from step S204 to step S207 by the sub-array signal extraction unit 13 and the electric power estimation unit 14. If the number n of the sub-array antenna SA(n) becomes N (“Yes” in step S207), in other words, if the calculation of the electric power pₖ(n) in each arrival direction k has been completed, the process is returned to the arrival direction estimation process shown in FIG. 7.

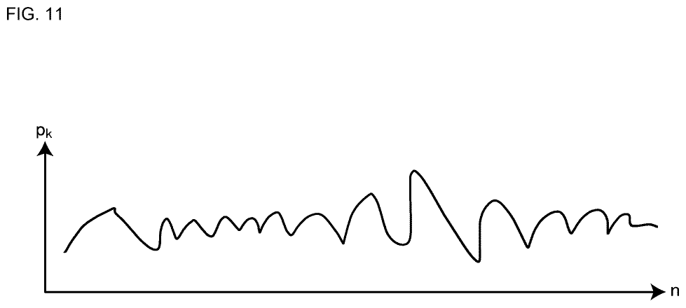

FIG. 11 is a graph obtained by plotting the electric power in the arrival direction in the arrangement direction of the sub-arrays. In FIG. 11, the vertical axis indicates the electric power pₖ in the arrival direction k, and the horizontal axis indicates the number n of the sub-array antenna SA(n). If the arrival direction k corresponds to the arrival direction estimation target Tp (see FIGS. 3A and 3B), it is expected that the variation in the electric power pₖ for each sub-array antennas SA(n) will be small. On the other hand, if the arrival direction k is a false image different from the arrival direction estimation target Tp, it is assumed that the variation in the electric power pₖ for each sub-array antenna SA(n) will be relatively large with respect to the arrival direction estimation target Tp.

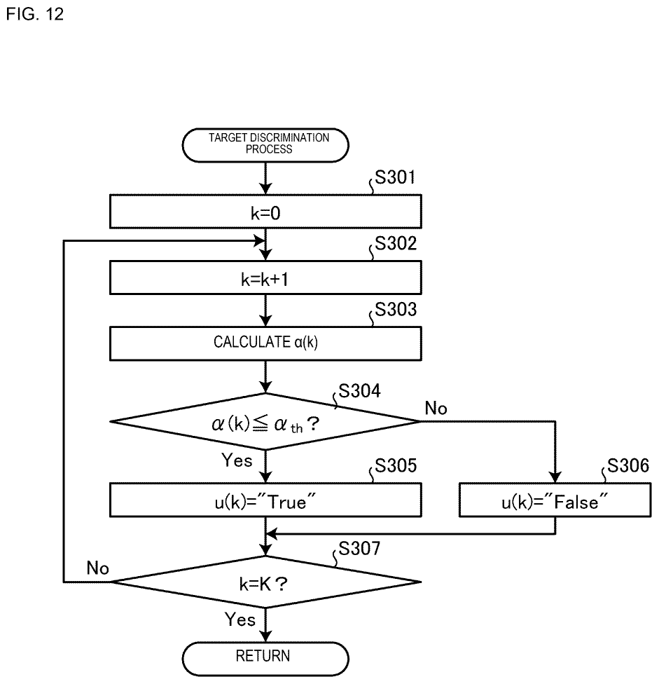

In the arrival direction estimation process shown in FIG. 7, the arrival direction estimation device 1 performs a comparison process between the variation amount of the electric power pₖ estimated for each sub-array antenna SA(n) and a predetermined value to determine true or false of the arrival direction k (a target discrimination process, step S003). The target discrimination process is executed by the target discrimination unit 15. FIG. 12 is a flowchart showing an example of the target discrimination process. Here, the concept of the process in the target discrimination unit 15 will be described first.

In the present embodiment, an average value pₐᵥ(k) of the electric power pₖ(n) in the arrival direction k is calculated using the following Equation (12), and a standard deviation pₒ(k) of the electric power pₖ(n) in the arrival direction k is calculated using the following Equation (13). Further, α(k) calculated by the following Equation (14) using the average value pₐᵥ(k) calculated using the following Equation (12) and the standard deviation pₒ(k) calculated using the following Equation (13) is defined as the variation amount of the electric power pₖ in the arrival direction k.

$$\begin{matrix}[ Equation 12 ] & \\ {p}_{a v} ( k ) = \frac{1}{N} {\sum }_{n = 1}^{N} {p}_{k} ( n ) & ( 12 )\end{matrix}$$

$$\begin{matrix}[ Equation 13 ] & \\ {p}_{σ} ( k ) = \sqrt{\frac{1}{N} {\sum }_{n = 1} {[ {p}_{k} ( n ) - {p}_{a v} ]}^{2}} & ( 13 )\end{matrix}$$

$$\begin{matrix}[ Equation 14 ] & \\ α ( k ) = 1 + \frac{{p}_{σ} ( k )}{{p}_{a v} ( k )} & ( 14 )\end{matrix}$$

The target discrimination unit 15 uses the above Equations (12) to (14) to calculate the variation amount α(k) of the electric power pₖ in the arrival direction k.

The variation amount of the electric power pₖ in the arrival direction k is not limited to that described above. Specifically, the variation amount of the electric power pₖ in the arrival direction k may also be, for example, an aspect in which the standard deviation pₒ(k) calculated using the above Equation (13) is used, or an aspect in which the dispersion value of the electric power pₖ(n) is used.

The target discrimination unit 15 compares and determines the variation amount (k) of the electric power pₖ in the arrival direction k obtained by the above Equations (12) to (14), for example, with a predetermined threshold αₜₕ. When the variation amount α(k) of the electric power pₖ in the arrival direction k is equal to or less than the threshold αₜₕ, the arrival direction k is regarded as the arrival direction estimation target Tp. Thus, the false images appearing in the directions different from the arrival direction estimation target Tp can be excluded.

The directions corresponding to the side lobes and the direction corresponding to the arrival direction estimation target Tp (see FIGS. 3A and 3B) estimated by each sub-array antenna SA(n) are different depending on the variation in the phase center for each sub-array antenna SA(n). The variation in the phase center for each sub-array antenna SA(n) causes the variation in the electric power from the side lobes. Therefore, the direction in which the electric power variation among the sub-array antennas SA(n) is large is assumed to be a false image.

Here, when the AF method is used as the arrival direction estimation technique in the target estimation unit 12, higher accuracy than that of an arrival direction estimation technique using the FFT, the BF method or the like is obtained, and the peak of the electric power from the arrival direction estimation target Tp can be accurately estimated. While the AF method is noted for its high angular resolution, the target estimation unit 12 may be configured to use any suitable direction-finding algorithm, including but not limited to, the aforementioned techniques. Thus, since the variation amount among the sub-array antennas SA(n) in the electric power from the false image is relatively larger, the accuracy of the target discrimination process (see FIG. 12) in the target discrimination unit 15 can be increased.

In the target discrimination process shown in FIG. 12, the arrival direction estimation device 1 initializes the number k of the arrival direction k (“k=0” in step S301), increments the number k (“k=k+1” in step S302), and executes the subsequent processes.

The target discrimination unit 15 uses the above Equations (12) to (14) to calculate the variation amount α(k) of the electric power pₖ in the arrival direction k (step S303), and determines whether the variation amount α(k) of the electric power pₖ in the arrival direction k is equal to or less than the predetermined threshold αₜₕ (“a(k)≤αₜₕ?” in step S304).

If the variation amount α(k) of the electric power pₖ in the arrival direction k is equal to or less than the threshold αₜₕ (a (k)≤ αₜₕ; “Yes” in step S304), the target discrimination unit 15 sets a value u(k) corresponding to the arrival direction k to Boolean value “True” (u(k)= “True” in step S305). If the variation amount α(k) of the electric power pₖ in the arrival direction k exceeds the threshold αₜₕ (“No” in step S304), the target discrimination unit 15 sets the value u(k) corresponding to the arrival direction k to Boolean value “False” (u(k)= “False” in step S306).

The arrival direction estimation device 1 determines whether or not the number k of the arrival direction k is K (step S307), and if the number k of the arrival direction k is not K (“No” in step S307), in other words, if the determination of true or false of all the arrival directions k has not been completed, returns the process to step S302, increments the number k of the arrival direction k (“k=k+1” in step S302), and repeats the processes from step S303 to step S307 by the target discrimination unit 15. If the number k of the arrival direction k becomes K (“Yes” in step S307), in other words, if the determination of true or false of all the arrival directions k is completed, the process is returned to the arrival direction estimation process shown in FIG. 7, and the arrival direction estimation process is completed.

The arrival direction estimation device 1 and the arrival direction estimation method according to the present disclosure can be used to improve, in a communication terminal device, the detection accuracy of the base station or another terminal device, for example. Specifically, for example, after performing the arrival direction estimation process shown in FIG. 7, the arrival direction estimation device 1 (the target discrimination unit 15) outputs, to the communication terminal device, the target angle θk corresponding to the arrival direction k with the value u(k) set to Boolean value “True” as the target angle θ_{Tp}. Thus, in the communication terminal device, the detection accuracy of the base station or another terminal device can be improved by using the target angle θ_{Tp} of the arrival direction estimation target Tp appropriately estimated by the arrival direction estimation process according to the embodiment, i.e., designate target angles having a low power variance as an arrival direction.

In addition, the arrival direction estimation device 1 and the arrival direction estimation method according to the present disclosure can be used to improve, in a radar device mounted on a mobile body such as an automobile, the estimation accuracy of a target position, for example. Specifically, for example, after performing the arrival direction estimation process shown in FIG. 7, the arrival direction estimation device 1 (the target discrimination unit 15) outputs, to the radar device, the target angle θk corresponding to the arrival direction k with the value u(k) set to Boolean value “True” as the target angle θ_{Tp}. Thus, in the radar device, the estimation accuracy of the target position can be improved by using the target angle θ_{Tp} of the arrival direction estimation target Tp appropriately estimated by the arrival direction estimation process according to the embodiment.

### (First Modification)

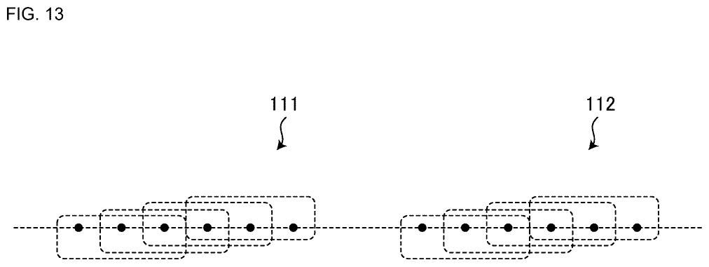

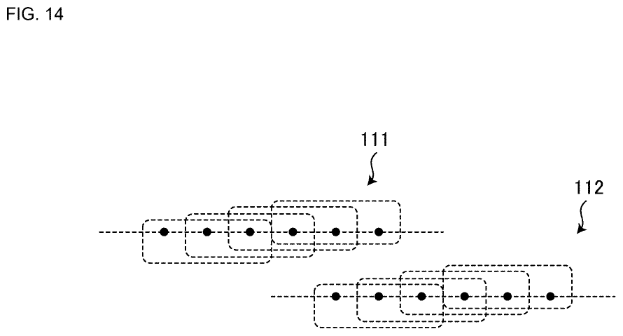

FIG. 13 is a conceptual diagram showing a first example of an antenna configuration according to a first modification of the embodiment. FIG. 14 is a conceptual diagram showing a second example of the antenna configuration according to the first modification of the embodiment. In FIG. 8 shows an example of an equal-interval linear array antenna in which the respective phase centers of the antenna elements A(m) are arranged at substantially equal intervals, but present disclosure includes a configuration that includes a plurality of equal-interval linear array antennas (array antennas 111 and 112). The first example of the first modification shown in FIG. 13 exemplifies an aspect in which the arrangement directions of the respective antenna elements of the two array antennas 111 and 112 overlap each other. The second example of the first modification shown in FIG. 14 exemplifies an aspect in which the arrangement directions of the respective antenna elements of the two array antennas 111 and 112 are arranged in parallel.

### (Second Modification)

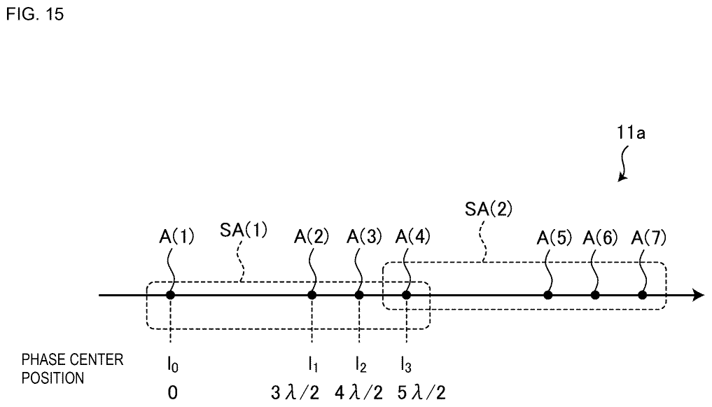

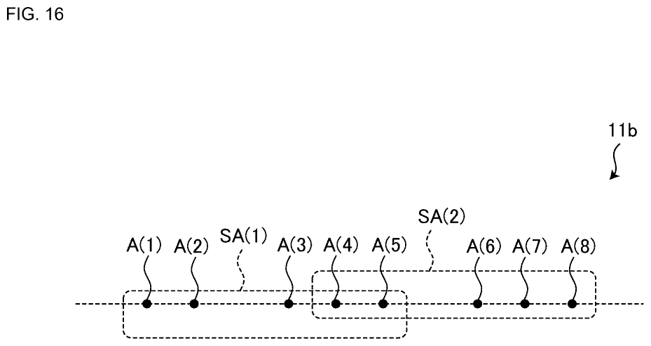

FIG. 15 is a conceptual diagram showing a first example of a sub-array configuration according to a second modification of the embodiment. FIG. 16 is a conceptual diagram showing a second example of the sub-array configuration according to the second modification of the embodiment. The second modification exemplifies an aspect in which array antennas 11a and 11b are each an unequal-interval linear array antenna in which respective phase centers of the antenna elements A(m) are arranged at unequal intervals. Thus, the degree of freedom in designing a beam pattern can be increased. Specifically, for example, a beam pattern in which a specific side lobe is suppressed can be adopted. In such a case, it is sufficient to set the interval between the antenna elements A(m) so that it matches a target beam pattern.

The first example of the second modification shown in FIG. 15 exemplifies an aspect in which the antenna element number R of each of the sub-array antennas SA(1) and SA(2) is 4, but the present discloser is not limited to such an aspect. It is sufficient that each of the sub-array antennas SA(1) and SA(2) has substantially the same interval between the respective phase centers of the antenna elements adjacent in the arrangement direction of the antenna elements A(r).

Specifically, in the first example of the second modification shown in FIG. 15, the interval between the phase center of the antenna element A(1) and the phase center of the antenna element A(2) included in the sub-array antenna SA(1) is substantially the same as the interval between the phase center of the antenna element A(4) and the phase center of the antenna element A(5) included in the sub-array antenna SA(2). Further, the interval between the phase center of the antenna element A(2) and the phase center of the antenna element A(3) included in the sub-array antenna SA(1) is substantially the same as the interval between the phase center of the antenna element A(5) and the phase center of the antenna element A(6) included in the sub-array antenna SA(2). Further, the interval between the phase center of the antenna element A(3) and the phase center of the antenna element A(4) included in the sub-array antenna SA(1) is substantially the same as the interval between the phase center of the antenna element A(6) and the phase center of the antenna element A(7) included in the sub-array antenna SA(2).

In the first example of the second modification shown in FIG. 15, the phase center position lₒ of the antenna element A(1) at one end (left end in FIG. 15) of the sub-array antenna SA(1) is set as a reference position (10=0), and the phase center position l₁ of the antenna element A(2) is set as 3λ/2, the phase center position 12 of the antenna element A(3) is set as 4λ/2 (=2)), and the phase center position 13 of the antenna element A(4) is set as 5λ/2.

In the first example of the second modification shown in FIG. 15, the matrix V shown in the above Equation (8) can be transformed into the following Equation (15) by applying the phase center position lᵣ₋₁ of each antenna element A(r) to w shown in the above Equation (9). An electric power estimation process similar to that of the embodiment (see FIG. 10) can be performed by applying a generalized inverse matrix V⁺ of a matrix V shown in the following Equation (15).

$$\begin{matrix}[ Equation 15 ] & \\ V = [ \begin{matrix}1 & 1 & … & 1 \\ {z}_{1}^{3} & {z}_{2}^{3} & … & {z}_{K}^{3} \\ {z}_{1}^{4} & {z}_{2}^{4} & … & {z}_{K}^{4} \\ {z}_{1}^{5} & {z}_{2}^{5} & … & {z}_{K}^{5}\end{matrix} ] & ( 15 )\end{matrix}$$

The second example of the second modification shown in FIG. 16 exemplifies an aspect in which the antenna element number R of each of the sub-array antennas SA(1) and SA(2) is 5, but the present discloser is not limited to such an aspect. It is sufficient that each of the sub-array antennas SA(1) and SA(2) has substantially the same interval between the respective phase centers of the antenna elements adjacent in the arrangement direction of the antenna elements A(r).

Specifically, in the second example of the second modification shown in FIG. 16, the interval between the phase center of the antenna element A(1) and the phase center of the antenna element A(2) included in the sub-array antenna SA(1) is substantially the same as the interval between the phase center of the antenna element A(4) and the phase center of the antenna element A(5) included in the sub-array antenna SA(2). Furthermore, the interval between the phase center of the antenna element A(2) and the phase center of the antenna element A(3) included in the sub-array antenna SA(1) is substantially the same as the interval between the phase center of the antenna element A(5) and the phase center of the antenna element A(6) included in the sub-array antenna SA(2). Further, the interval between the phase center of the antenna element A(3) and the phase center of the antenna element A(4) included in the sub-array antenna SA(1) is substantially the same as the interval between the phase center of the antenna element A(6) and the phase center of the antenna element A(7) included in the sub-array antenna SA(2). Further, the interval between the phase center of the antenna element A(4) and the phase center of the antenna element A(5) included in the sub-array antenna SA(1) is substantially the same as the interval between the phase center of the antenna element A(7) and the phase center of the antenna element A(8) included in the sub-array antenna SA(2).

In the second example of the second modification example shown in FIG. 16 also, by applying the phase center position lᵣ₋₁ of each antenna element A(r) to w shown in the above Equation (9) and transforming the matrix V shown in the above Equation (8), an electric power estimation process similar to that of the embodiment (see FIG. 10) can be performed using the generalized inverse matrix V⁺ of the matrix V.

In the second modification in which the unequal-interval linear array antenna described above are used, the BF method, the MUSIC method or the like can be used as the arrival direction estimation technique in the target estimation unit 12.

It should be noted that the embodiment described above is intended to facilitate understanding of the present disclosure, and is not intended to limit the interpretation of the present disclosure. The present disclosure may be changed/improved without departing from its scope, and the present disclosure also includes equivalents thereof.

The present disclosure may have the following configurations as described above or in lieu of the above.

(1) An arrival direction estimation device according to an aspect of the present disclosure, comprising: an array antenna having a plurality of antenna elements, respective phase centers of the plurality of antenna elements being arranged in one direction; a target estimation unit that estimates an arrival direction of a radio wave based on a reception signal for each of the antenna elements; an electric power estimation unit that estimates an electric power in the arrival direction for each of a plurality of sub-array antennas each including the same number of the antenna elements; and a target discrimination unit that determines, when a variation amount of the electric power in the arrival direction estimated for each of the sub-array antennas is equal to or less than a predetermined value, the arrival direction as an arrival direction estimation target.

With such a configuration, the arrival direction estimation target and false images caused by the side lobes can be discriminated, and the influence of the side lobes, which increase due to the phase shift between the antenna elements, can be suppressed. In addition, it is possible to appropriately estimate the arrival direction of radio waves by a simple configuration.

(2) The arrival direction estimation device according to the above (1), wherein the plurality of sub-array antennas have substantially the same interval between the phase center of a first antenna element and the phase center of a second antenna element adjacent in an arrangement direction of the antenna elements.
(3) The arrival direction estimation device according to the above (2), wherein in the array antenna, the respective phase centers of the plurality of antenna elements are arranged at substantially equal intervals.
(4) The arrival direction estimation device according to the above (3), wherein the target estimation unit estimates the arrival direction of the radio wave using an annihilating filter method.
(5) The arrival direction estimation device according to any one of the above (2) to (4), wherein the target estimation unit calculates a phase difference zₖ between the antenna elements in the arrival direction (k is an integer from 1 to a total number K of the arrival directions), and the electric power estimation unit uses the following Equations (16) to (21) to calculate an electric power pₖ(n) in the arrival direction for each sub-array antenna, when the wavelength of a reception radio wave is A, the total number of the sub-array antennas is N, the number of the antenna elements included in the sub-array antenna is R, the reception signal for each of the antenna elements included in the sub-array antenna is Xₙ+r-1 (n is an integer from 1 to N, and r is an integer from 1 to R), the phase center position of each of the antenna elements is lᵣ₋₁ with the phase center position of an antenna element at one end of the sub-array antenna defined as a reference position, and a complex amplitude for each arrival direction is Sₖ(n).

$$\begin{matrix}[ Equation 16 ] & \\ {w}_{r} = \frac{2 {I}_{r}}{λ} & ( 16 )\end{matrix}$$

$$\begin{matrix}[ Equation 17 ] & \\ V = [ \begin{matrix}{z}_{1}^{{w}_{0}} & {z}_{2}^{{w}_{0}} & … & {z}_{K}^{{w}_{0}} \\ {z}_{1}^{{w}_{1}} & {z}_{2}^{{w}_{1}} & … & {z}_{K}^{{w}_{1}} \\ {z}_{1}^{{w}_{2}} & {z}_{2}^{{w}_{2}} & ⋱ & {z}_{K}^{{w}_{2}} \\ ⋮ & ⋮ & … & ⋮ \\ {z}_{1}^{{w}_{R - 1}} & {z}_{2}^{{w}_{R - 1}} & … & {z}_{K}^{{w}_{R - 1}}\end{matrix} ] & ( 17 )\end{matrix}$$

$$\begin{matrix}[ Equation 18 ] & \\ {X}_{n} = [ \begin{matrix}{x}_{n} \\ {x}_{n + 1} \\ ⋮ \\ {x}_{n + ( R - 1 ) - 1} \\ {x}_{n + ( R - 1 )}\end{matrix} ] & ( 18 )\end{matrix}$$

$$\begin{matrix}[ Equation 19 ] & \\ {S}_{n} = [ \begin{matrix}{s}_{1} ( n ) \\ {s}_{2} ( n ) \\ ⋮ \\ {s}_{K - 1} ( n ) \\ {s}_{K} ( n )\end{matrix} ] & ( 19 )\end{matrix}$$

$$\begin{matrix}[ Equation 20 ] & \\ {S}_{n} = {V}^{+} {X}_{n} & ( 20 )\end{matrix}$$

$$\begin{matrix}[ Equation 21 ] & \\ {p}_{k} ( n ) = {\vert {s}_{k} ( n ) \vert}^{2} & ( 21 )\end{matrix}$$

(6) The arrival direction estimation device according to the above (5), wherein the target discrimination unit uses the following Equation (22) to calculate an average value Pₐᵥ(k) of the electric power pₖ(n) in the arrival direction for each sub-array antenna, uses the following Equation (23) to calculate a standard deviation pₒ (k) of the electric power pₖ(n) in the arrival direction for each sub-array antenna, and uses the following Equation (24) to calculate a variation amount α(k) of the electric power pₖ(n) in the arrival direction for each sub-array antenna.

$$\begin{matrix}[ Equation 22 ] & \\ {p}_{a v} ( k ) = \frac{1}{N} {\sum }_{n = 1}^{N} {p}_{k} ( n ) & ( 22 )\end{matrix}$$

$$\begin{matrix}[ Equation 23 ] & \\ {p}_{σ} ( k ) = \sqrt{\frac{1}{N} {\sum }_{n = 1}^{N} {[ {p}_{k} ( n ) - {p}_{a v} ]}^{2}} & ( 23 )\end{matrix}$$

$$\begin{matrix}[ Equation 24 ] & \\ α ( k ) = 1 + \frac{{p}_{σ} ( k )}{{p}_{a v} ( k )} & ( 24 )\end{matrix}$$

(7) An arrival direction estimation method according to an aspect of the present disclosure, comprising: a target estimation step that estimates an arrival direction of a radio wave based on a reception signal for each of antenna elements whose respective phase centers are arranged in one direction; an electric power estimation step that estimates an electric power in the arrival direction for each of a plurality of sub-array antennas each including the same number of the antenna elements; and a target determination step that determines, if a variation amount of the electric power in an arrival direction estimated for each of the sub-array antennas is equal to or less than a predetermined value, the arrival direction as an arrival direction estimation target.

With such a configuration, the arrival direction estimation target and false images caused by the side lobes can be discriminated, and the influence of the side lobes, which increase due to the phase shift between the antenna elements, can be suppressed. Moreover, the arrival direction of radio waves can be appropriately estimated by simple processing.

(8) The arrival direction estimation method according to the above (7), wherein the plurality of sub-array antennas have substantially the same interval between the phase center of a first antenna element and the phase center of a second antenna element adjacent in an arrangement direction of the antenna elements.
(9) The arrival direction estimation method according to the above (8), wherein the respective phase centers of the plurality of antenna elements are arranged at substantially equal intervals.
(10) The arrival direction estimation method according to the above (9), wherein in the target estimation step, the arrival direction of the radio wave is estimated using an annihilating filter method.
(11) The arrival direction estimation method according to any one of the above (8) to (10), wherein in the target estimation step, a phase difference zₖ between the antenna elements in the arrival direction (k is an integer from 1 to a total number K of the arrival directions) is calculated, and in the electric power estimation step, the following Equations (25) to (30) are used to calculate an electric power pₖ(n) in the arrival direction for each sub-array antenna, when the wavelength of a reception radio wave is A, the total number of the sub-array antennas is N, the number of the antenna elements included in the sub-array antenna is R, the reception signal for each of the antenna elements included in the sub-array antenna is Xₙ₊ᵣ₋₁ (n is an integer from 1 to N, and r is an integer from 1 to R), the phase center position of each of the antenna elements is lᵣ₋₁ with the phase center position of an antenna element at one end of the sub-array antenna defined as a reference position, and a complex amplitude for each arrival direction is Sₖ(n).

$$\begin{matrix}[ Equation 25 ] & \\ {w}_{r} = \frac{2 {I}_{r}}{λ} & ( 25 )\end{matrix}$$

$$\begin{matrix}[ Equation 26 ] & \\ V = [ \begin{matrix}{z}_{1}^{{w}_{0}} & {z}_{2}^{{w}_{0}} & … & {z}_{K}^{{w}_{0}} \\ {z}_{1}^{{w}_{1}} & {z}_{2}^{{w}_{1}} & … & {z}_{K}^{{w}_{1}} \\ {z}_{1}^{{w}_{2}} & {z}_{2}^{{w}_{2}} & ⋱ & {z}_{K}^{{w}_{2}} \\ ⋮ & ⋮ & … & ⋮ \\ {z}_{1}^{{w}_{R - 1}} & {z}_{2}^{{w}_{R - 1}} & … & {z}_{K}^{{w}_{R - 1}}\end{matrix} ] & ( 26 )\end{matrix}$$

$$\begin{matrix}[ Equation 27 ] & \\ {X}_{n} = [ \begin{matrix}{x}_{n} \\ {x}_{n + 1} \\ ⋮ \\ {x}_{n + ( R - 1 ) - 1} \\ {x}_{n + ( R - 1 )}\end{matrix} ] & ( 27 )\end{matrix}$$

$$\begin{matrix}[ Equation 28 ] & \\ {S}_{n} = [ \begin{matrix}{s}_{1} ( n ) \\ {s}_{2} ( n ) \\ ⋮ \\ {s}_{K - 1} ( n ) \\ {s}_{K} ( n )\end{matrix} ] & ( 28 )\end{matrix}$$

$$\begin{matrix}[ Equation 29 ] & \\ {S}_{n} = {V}^{+} {X}_{n} & ( 29 )\end{matrix}$$

$$\begin{matrix}[ Equation 30 ] & \\ {p}_{k} ( n ) = {\vert {s}_{k} ( n ) \vert}^{2} & ( 30 )\end{matrix}$$

(12) The arrival direction estimation method according to the above (11), wherein in the target determination step, the following Equation (31) is used to calculate an average value pₐᵥ (k) of the electric power pₖ(n) in the arrival direction for each sub-array antenna, the following Equation (32) is used to calculate a standard deviation pₒ(k) of the electric power pₖ(n) in the arrival direction for each sub-array antenna, and the following Equation (33) is used to calculate a variation amount α(k) of the electric power pₖ(n) in the arrival direction for each sub-array antenna.

$$\begin{matrix}[ Equation 31 ] & \\ {p}_{a v} ( k ) = \frac{1}{N} {\sum }_{n = 1}^{N} {p}_{k} ( t ) & ( 31 )\end{matrix}$$

$$\begin{matrix}[ Equation 32 ] & \\ {p}_{σ} ( k ) = \sqrt{\frac{1}{N} {\sum }_{n = 1}^{N} {[ {p}_{k} ( n ) - {p}_{av} ]}^{2}} & ( 32 )\end{matrix}$$

$$\begin{matrix}[ Equation 33 ] & \\ α ( k ) = 1 + \frac{{p}_{σ} ( k )}{{p}_{av} ( k )} & ( 33 )\end{matrix}$$

According to the present disclosure, it is possible to realize an arrival direction estimation device and an arrival direction estimation method capable of appropriately estimating the arrival direction of radio waves by a simple configuration or processing.

### REFERENCE SIGNS LIST

1 arrival direction estimation device
11, 11a, 11b, 111, 112 array antenna
12 target estimation unit
13 sub-array signal extraction unit
14 electric power estimation unit
15 target discrimination unit
A(m) antenna element
SA(n) sub-array antenna

1. An arrival direction estimation device comprising:
an array antenna having a plurality of antenna elements, respective phase centers of the plurality of antenna elements being arranged in one direction;
a target estimation circuit configured to estimate an arrival direction of a radio wave based on respective reception signals for each of the plurality of antenna elements;
an electric power estimation circuit configured to estimate an electric power in the arrival direction for each of a plurality of sub-array antennas each including a same number of the antenna elements; and
a target discrimination circuit configured to determine, if a variation amount of the estimated electric power across the plurality of sub-array antennas is equal to or less than a predetermined value, and designate that arrival direction as an arrival direction estimation target.

2. The arrival direction estimation device according to claim 1, wherein each of the plurality of sub-array antennas has an identical spatial arrangement of antenna elements.

3. The arrival direction estimation device according to claim 2, wherein in the array antenna, the respective phase centers of the plurality of antenna elements are arranged at substantially equal intervals.

4. The arrival direction estimation device according to claim 3, wherein the target estimation circuit is configured to estimate the arrival direction of the radio wave using an annihilating filter method.

5. The arrival direction estimation device according to claim 2, wherein
the target estimation circuit is configured to calculate a phase difference Zₖ between the antenna elements in the arrival direction (k is an integer from 1 to a total number K of the arrival directions), and
the electric power estimation circuit is configured to use the following Equations (1) to (6) to calculate an electric power pₖ(n) in the arrival direction for each sub-array antenna, when the wavelength of a reception radio wave is A, the total number of the sub-array antennas is N, the number of the antenna elements included in the sub-array antenna is R, the reception signal for each of the antenna elements included in the sub-array antenna is Xₙ₊ᵣ₋₁ (n is an integer from 1 to N, and r is an integer from 1 to R), the phase center position of each of the antenna elements is lᵣ₋₁ with the phase center position of an antenna element at one end of the sub-array antenna defined as a reference position, and a complex amplitude for each arrival direction is sₖ(n).
$$\begin{matrix}[ Equation 1 ] & \\ {w}_{r} = \frac{2 {I}_{r}}{λ} & ( 1 )\end{matrix}$$
$$\begin{matrix}[ Equation 2 ] & \\ V = [ \begin{matrix}{z}_{1}^{{w}_{0}} & {z}_{2}^{{w}_{0}} & … & {z}_{K}^{{w}_{0}} \\ {z}_{1}^{{w}_{1}} & {z}_{2}^{{w}_{1}} & … & {z}_{K}^{{w}_{1}} \\ {z}_{1}^{{w}_{2}} & {z}_{2}^{{w}_{2}} & ⋱ & {z}_{K}^{{w}_{2}} \\ ⋮ & ⋮ & … & ⋮ \\ {z}_{1}^{{w}_{R - 1}} & {z}_{2}^{{w}_{R - 1}} & … & {z}_{K}^{{w}_{R - 1}}\end{matrix} ] & ( 2 )\end{matrix}$$
$$\begin{matrix}[ Equation 3 ] & \\ {X}_{n} = [ \begin{matrix}{x}_{n} \\ {x}_{n + 1} \\ ⋮ \\ {x}_{n + ( R - 1 ) - 1} \\ {x}_{n + ( R - 1 )}\end{matrix} ] & ( 3 )\end{matrix}$$
$$\begin{matrix}[ Equation 4 ] & \\ {S}_{n} = [ \begin{matrix}{s}_{1} ( n ) \\ {s}_{2} ( n ) \\ ⋮ \\ {s}_{K - 1} ( n ) \\ {s}_{K} ( n )\end{matrix} ] & ( 4 )\end{matrix}$$
$$\begin{matrix}[ Equation 5 ] & \\ {S}_{n} = {V}^{+} {X}_{n} & ( 5 )\end{matrix}$$
$$\begin{matrix}[ Equation 6 ] & \\ {p}_{k} ( n ) = {\vert {s}_{k} ( n ) \vert}^{2} . & ( 6 )\end{matrix}$$

6. The arrival direction estimation device according to claim 5, wherein the target discrimination unit uses the following Equation (7) to calculate an average value Pₐᵥ(k) of the electric power pₖ(n) in the arrival direction for each sub-array antenna, uses the following Equation (8) to calculate a standard deviation pₒ(k) of the electric power pₖ(n) in the arrival direction for each sub-array antenna, and uses the following Equation (9) to calculate a variation amount α(k) of the electric power pₖ(n) in the arrival direction for each sub-array antenna.
$$\begin{matrix}[ Equation 7 ] & \\ {p}_{av} ( k ) = \frac{1}{N} {\sum }_{n = 1}^{N} {p}_{k} ( n ) & ( 7 )\end{matrix}$$
$$\begin{matrix}[ Equation 8 ] & \\ {p}_{σ} ( k ) = \sqrt{\frac{1}{N} {\sum }_{n = 1}^{N} {[ {p}_{k} ( n ) - {p}_{av} ]}^{2}} & ( 8 )\end{matrix}$$
$$\begin{matrix}[ Equation 9 ] & \\ α ( k ) = 1 + \frac{{p}_{σ} ( k )}{{p}_{av} ( k )} . & ( 9 )\end{matrix}$$

7. The device of claim 2, wherein the array antenna is an unequal-interval linear array antenna.

8. The device of claim 2, wherein the plurality of sub-array antennas are overlapping.

9. The device of claim 8, wherein the plurality of sub-array antennas are formed by shifting a selection of consecutive antenna elements by one element along the one direction of the array antenna.

10. The device of claim 1, wherein the target discrimination circuit is further configured to output only the arrival direction estimation target.

11. An arrival direction estimation method comprising:
estimating an arrival direction of a radio wave based on respective reception signals for each of a plurality of antenna elements whose respective phase centers are arranged in one direction;
estimating an electric power in the arrival direction for each of a plurality of sub-array antennas each including a same number of the antenna elements;
determining, for each arrival direction, whether a variation amount of the estimated electric power across the sub-array antennas is equal to or less than a predetermined value; and
in response to the variation amount being equal to or less than the predetermined value, designating that arrival direction as an arrival direction estimation target.

12. The arrival direction estimation method according to claim 11, wherein each of the plurality of sub-array antennas has an identical spatial arrangement of antenna elements.

13. The arrival direction estimation method according to claim 12, wherein the respective phase centers of the plurality of antenna elements are arranged at substantially equal intervals.

14. The arrival direction estimation method according to claim 13, wherein estimating the arrival direction of the radio wave uses an annihilating filter method.

15. The arrival direction estimation method according to claim 12, wherein
target estimating includes calculating a phase difference zₖ between the antenna elements in the arrival direction (k is an integer from 1 to a total number K of the arrival directions), and
electric power estimating includes using the following Equations (10) to (15) to calculate an electric power pₖ(n) in the arrival direction for each sub-array antenna, when the wavelength of a reception radio wave is A, the total number of the sub-array antennas is N, the number of the antenna elements included in the sub-array antenna is R, the reception signal for each of the antenna elements included in the sub-array antenna is Xₙ₊ᵣ₋₁ (n is an integer from 1 to N, and r is an integer from 1 to R), the phase center position of each of the antenna elements is lᵣ₋₁ with the phase center position of an antenna element at one end of the sub-array antenna defined as a reference position, and a complex amplitude for each arrival direction is Sₖ(n).
$$\begin{matrix}[ Equation 10 ] & \\ {w}_{r} = \frac{2 {I}_{r}}{λ} & ( 10 )\end{matrix}$$
$$\begin{matrix}[ Equation 11 ] & \\ V = [ \begin{matrix}{z}_{1}^{{w}_{0}} & {z}_{2}^{{w}_{0}} & … & {z}_{K}^{{w}_{0}} \\ {z}_{1}^{{w}_{1}} & {z}_{2}^{{w}_{1}} & … & {z}_{K}^{{w}_{1}} \\ {z}_{1}^{{w}_{2}} & {z}_{2}^{{w}_{2}} & ⋱ & {z}_{K}^{{w}_{2}} \\ ⋮ & ⋮ & … & ⋮ \\ {z}_{1}^{{w}_{R - 1}} & {z}_{2}^{{w}_{R - 1}} & … & {z}_{K}^{{w}_{R - 1}}\end{matrix} ] & ( 11 )\end{matrix}$$
$$\begin{matrix}[ Equation 12 ] & \\ {X}_{n} = [ \begin{matrix}{x}_{n} \\ {x}_{n + 1} \\ ⋮ \\ {x}_{n + ( R - 1 ) - 1} \\ {x}_{n + ( R - 1 )}\end{matrix} ] & ( 12 )\end{matrix}$$
$$\begin{matrix}[ Equation 13 ] & \\ {S}_{n} = [ \begin{matrix}{s}_{1} ( n ) \\ {s}_{2} ( n ) \\ ⋮ \\ {s}_{K - 1} ( n ) \\ {s}_{K} ( n )\end{matrix} ] & ( 13 )\end{matrix}$$
$$\begin{matrix}[ Equation 14 ] & \\ {S}_{n} = {V}^{+} {X}_{n} & ( 14 )\end{matrix}$$
$$\begin{matrix}[ Equation 15 ] & \\ {p}_{k} ( n ) = {\vert {s}_{k} ( n ) \vert}^{2} . & ( 15 )\end{matrix}$$

16. The arrival direction estimation method according to claim 15, wherein in the target determining, using the following Equation (16) to calculate an average value pₐᵥ (k) of the electric power pₖ(n) in the arrival direction for each sub-array antenna, the following Equation (17) is used to calculate a standard deviation pₒ(k) of the electric power pₖ(n) in the arrival direction for each sub-array antenna, and the following Equation (18) is used to calculate a variation amount α(k) of the electric power pₖ(n) in the arrival direction for each sub-array antenna.
$$\begin{matrix}[ Equation 16 ] & \\ {p}_{a v} ( k ) = \frac{1}{N} {\sum }_{n = 1}^{N} {p}_{k} ( n ) & ( 16 )\end{matrix}$$
$$\begin{matrix}[ Equation 17 ] & \\ {p}_{σ} ( k ) = \sqrt{\frac{1}{N} {\sum }_{n = 1}^{N} {[ {p}_{k} ( n ) - {p}_{av} ]}^{2}} & ( 17 )\end{matrix}$$
$$\begin{matrix}[ Equation 18 ] & \\ α ( k ) = 1 + \frac{{p}_{σ} ( k )}{{p}_{av} ( k )} . & ( 18 )\end{matrix}$$

17. The arrival direction estimation method according to claim 12, wherein the variation amount is calculated as a ratio of a standard deviation of the estimated electric power across the plurality of sub-array antennas to an average value of the estimated electric power across the plurality of sub-array antennas.

18. A non-transitory computer-readable medium storing instructions that, when executed by a processor, cause the processor to perform a method comprising:
estimating an arrival direction of a radio wave based on respective reception signals from a plurality of antenna elements of an array antenna, wherein respective phase centers of the plurality of antenna elements are arranged in one direction;
estimating, for each arrival direction, an electric power for each of a plurality of sub-array antennas, each sub-array antenna comprising a same number of the antenna elements; and
determining, for each arrival direction, if a variation amount of the estimated electric power across the plurality of sub-array antennas is equal to or less than a predetermined value, and if so, designating that arrival direction as an arrival direction estimation target.
